(19) United States
(12) Patent Application Publication
(10) Pub. No.: US 2026/0371054 A1
(43) Pub. Date: Nov. 19, 2026

(54) SYSTEMS AND METHODS FOR PROVIDING DISASTER ROAMING POLICY SUPPORT

(71) Applicant: Verizon Patent and Licensing Inc., Basking Ridge, NJ (US)

(72) Inventors: Lixia YAN, Basking Ridge, NJ (US); Robert AVANES, Roanoke, TX (US); Ali Imdad MALIK, East Brunswick, NJ (US); Violeta CAKULEV, Milburn, NJ (US)

(73) Assignee: Verizon Patent and Licensing Inc., Basking Ridge, NJ (US)

(21) Appl. No.: 19/208,696

(22) Filed: May 15, 2025

(51) Int. Cl. H04W 4/90; H04W 48/18; H04W 60/04; H04W 84/04

(52) U.S. Cl. CPC H04W 4/90; H04W 48/18; H04W 60/04; H04W 84/042

(57) ABSTRACT

A network device may receive a policy association create message associated with a user equipment and indicating a registration type as disaster roaming, and may identify the registration type as disaster roaming based on the policy association create message. The network device may generate a disaster roaming policy for the user equipment based on identifying the registration type as disaster roaming, and may provide the disaster roaming policy to one or more network functions to provide differentiated network treatment for the user equipment during a disaster roaming event.

### BACKGROUND

Disaster roaming enables any user equipment (UE) on any cellular network to access any available cellular network during an emergency condition (e.g., a natural disaster).

### BRIEF DESCRIPTION OF THE DRAWINGS

FIGS. 1A-1C are diagrams of an example associated with providing disaster roaming policy support.

FIG. 2 is a diagram of an example environment in which systems and/or methods described herein may be implemented.

FIG. 3 is a diagram of example components of one or more devices of FIG. 2.

FIG. 4 is a flowchart of an example process for providing disaster roaming policy support.

### DETAILED DESCRIPTION OF EXAMPLE EMBODIMENTS

The following detailed description of example implementations refers to the accompanying drawings. The same reference numbers in different drawings may identify the same or similar elements.

Disaster situations, such as hurricanes, wildfires, or other large-scale emergencies, can severely disrupt regular cellular network coverage. In such scenarios, maintaining connectivity becomes vital for emergency communications and public safety. To address this, disaster roaming has been implemented as a feature allowing UEs (e.g., mobile phones) to connect to any available cellular network, regardless of a user’s subscribed service provider or existing roaming agreements. This ensures uninterrupted access to network services during emergencies when normal operations are compromised.

However, current network protocols lack the ability to distinguish disaster roaming from regular roaming. Specifically, a policy control function (PCF) in a fifth-generation (5G) network architecture cannot differentiate between subscribers engaging in disaster roaming and those engaged in standard roaming. This limitation arises because information exchanged between an access and mobility management function (AMF) and the PCF, as well as between a session management function (SMF) and the PCF, does not include specific indications related to disaster roaming scenarios. Thus, current techniques for handling disaster roaming consume computing resources (e.g., processing resources, memory resources, communication resources, and/or the like), networking resources, and/or other resources associated with failing to implement customized policies for disaster roaming users, creating inefficiencies in resource allocation and quality of service (QoS) management due to failing to implement customized policies for disaster roaming users, impacting the reliability and performance of emergency communications, and/or the like.

Some implementations described herein provide disaster roaming policy support. For example, a network device may receive a policy association create message associated with a user equipment and indicating a registration type as disaster roaming, and may identify the registration type as disaster roaming based on the policy association create message. The network device may generate a disaster roaming policy for the user equipment based on identifying the registration type as disaster roaming, and may provide the disaster roaming policy to one or more network functions to provide differentiated network treatment for the user equipment during a disaster roaming event.

In this way, implementations described herein provide disaster roaming policy support. For example, the implementations enable 5G networks to differentiate disaster roaming from regular roaming and implement policies optimized for emergency scenarios. By prioritizing network resources for disaster roaming users and tailoring QoS parameters for emergency situations, the implementations may prevent inefficient allocation of resources during large-scale emergencies. Additionally, the implementations improve the technical reliability of emergency communications by implementing differentiated resource management and policy adjustments, thereby avoiding unnecessary network congestion and ensuring efficient utilization of limited bandwidth and other communication infrastructure resources. Thus, the implementations may conserve computing resources, networking resources, and/or other resources that would have otherwise been consumed by failing to implement customized policies for disaster roaming users, creating inefficiencies in resource allocation and QoS management due to failing to implement customized policies for disaster roaming users, impacting the reliability and performance of emergency communications, and/or the like.

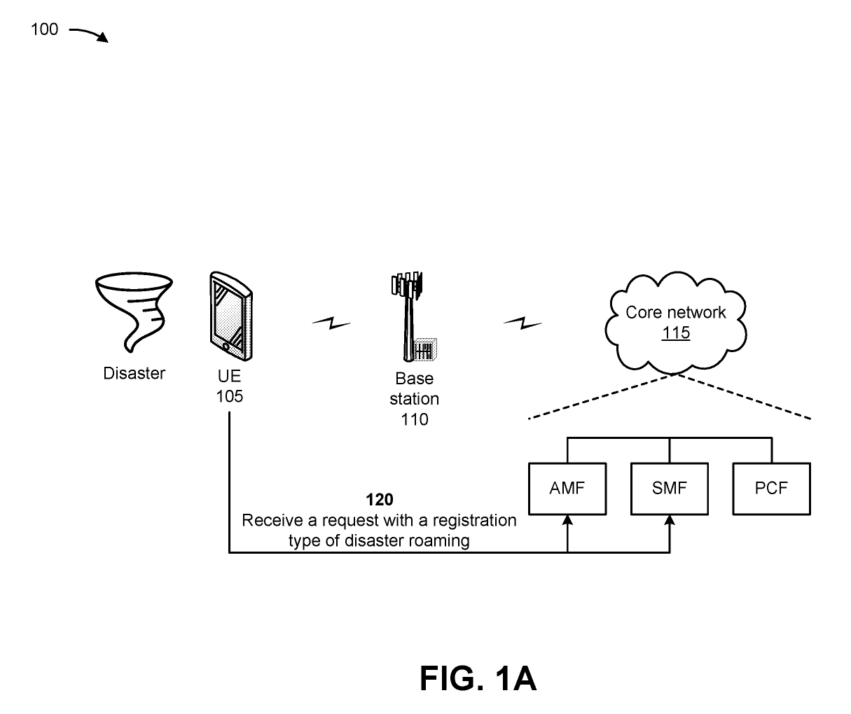

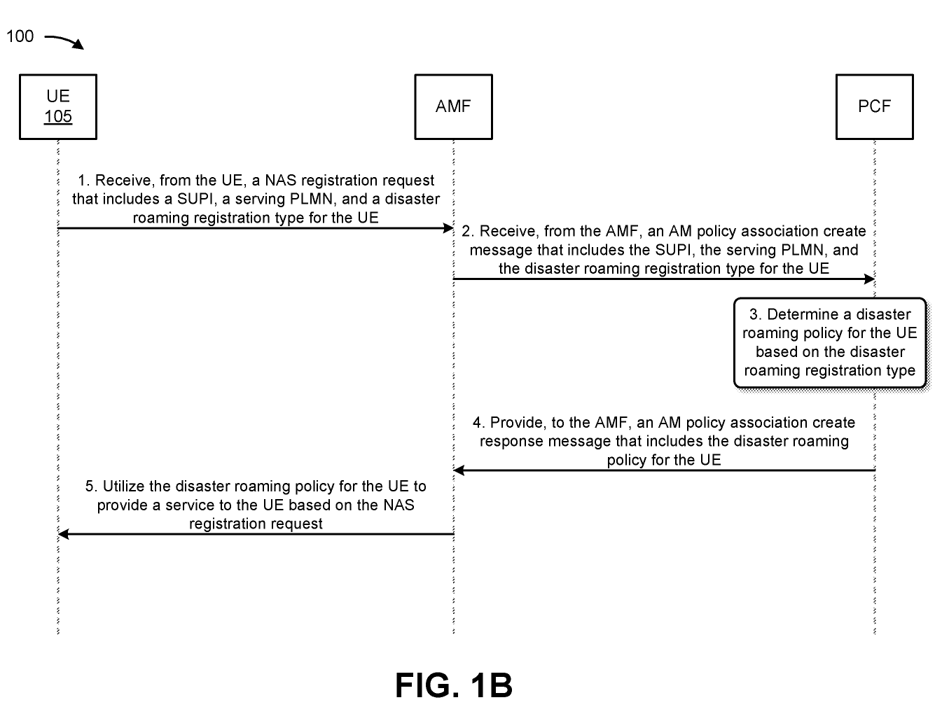

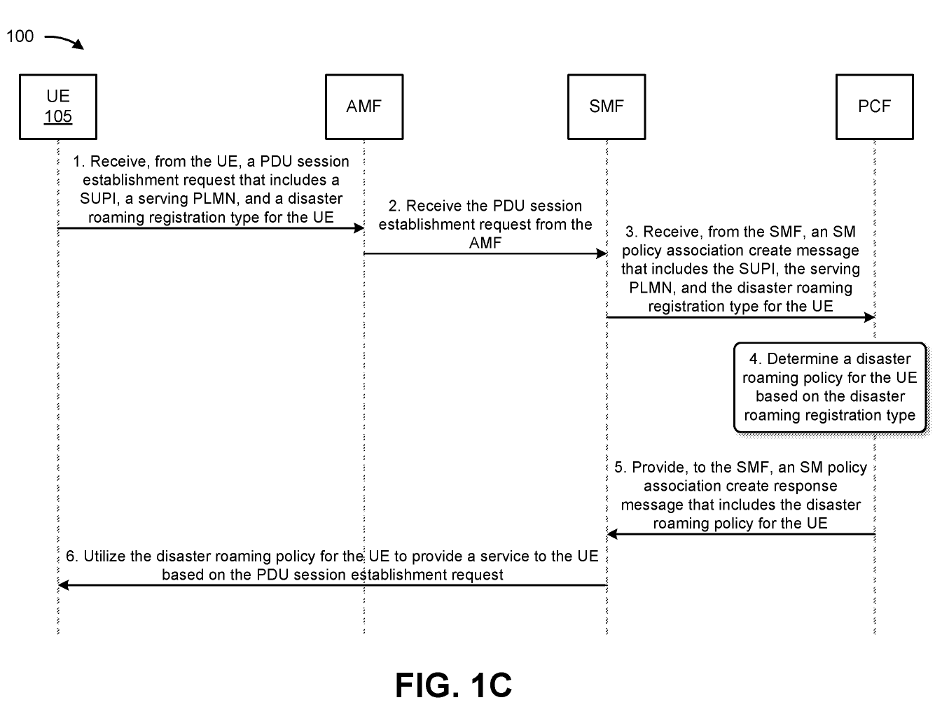

FIGS. 1A-1C are diagrams of an example 100 associated with providing disaster roaming policy support. As shown in FIGS. 1A-1C, the example 100 includes a UE 105 associated with a base station 110, and a core network 115. The core network 115 may include an access and mobility management function (AMF), a session management function (SMF), and a policy control function (PCF). Further details of the UE 105, the base station 110, the core network 115, the AMF, the SMF, and the PCF are provided elsewhere herein.

As shown in FIG. 1A, and by reference number 120, the AMF or the SMF may receive a request with a registration type of disaster roaming from the UE 105. For example, the UE 105 may experience a disaster event (e.g., an earthquake, a hurricane, a wildfire, or another large-scale emergency), and may generate the request with the registration type of disaster roaming based on experiencing the disaster event. In some implementations, the UE 105 may generate a network access stratum (NAS) registration request that includes the registration type of disaster roaming. Alternatively, the UE 105 may generate a packet data unit (PDU) session establishment request that includes the registration type of disaster roaming. The UE 105 may provide the NAS registration request with the registration type of disaster roaming to the AMF, and the AMF may receive the NAS registration request from the UE 105. Alternatively, the UE 105 may provide the PDU session establishment request with the registration type of disaster roaming to the SMF, and the SMF may receive the PDU session establishment request from the UE 105.

FIG. 1B depicts an example information flow associated with providing disaster roaming policy support. As shown at step 1 of FIG. 1B, the AMF may receive, from the UE 105, an NAS registration request that includes a subscriber permanent identifier (SUPI), a serving public land mobile network (PLMN), and a disaster roaming registration type for the UE 105. For example, based on a disaster event, the UE 105 may generate the NAS registration request that includes the SUPI, the serving PLMN, and the disaster roaming registration type for the UE 105. The UE 105 may provide the NAS registration request to the AMF, and the AMF may receive the NAS registration request from the UE 105. In some implementations, the UE 105 may provide the NAS registration request to the AMF as part of initiating disaster roaming, ensuring that the UE 105 can access network services during the disaster event without the need for traditional roaming agreements.

As shown at step 2 of FIG. 1B, the PCF may receive, from the AMF, an access and mobility management (AM) policy association create message that includes the SUPI, the serving PLMN, and the disaster roaming registration type for the UE 105. For example, the AMF may generate the AM policy association create message based on receiving the NAS registration request from the UE 105. The AMF may include the SUPI, the serving PLMN, and the disaster roaming registration type for the UE 105 in the AM policy association create message. The AMF may provide the AM policy association create message (e.g., with the SUPI, the serving PLMN, and the disaster roaming registration type for the UE 105) to the PCF, and the PCF may receive the AM policy association create message from the AMF. The AM policy association create message may enable the PCF to recognize the context of the disaster roaming registration, and to facilitate creation of a specialized policy for the UE 105.

As shown at step 3 of FIG. 1B, the PCF may determine a disaster roaming policy for the UE 105 based on the disaster roaming registration type. For example, when the PCF receives the AM policy association create message, the PCF may determine the disaster roaming policy for the UE 105 based on the disaster roaming registration type included in the AM policy association create message. In some implementations, the PCF may analyze the disaster roaming registration type and other contextual information to formulate a policy that optimizes network resource allocation and QoS parameters for emergency conditions. Additionally, or alternatively, the PCF may determine the disaster roaming policy based on historical data or a predictive analytics model that anticipates network needs during a disaster, rather than solely based on the disaster roaming registration type. For example, the PCF may utilize a machine learning model (e.g., trained on past disaster scenarios) to proactively adapt the disaster roaming policy to ensure optimal resource distribution during emergencies.

As shown at step 4 of FIG. 1B, the PCF may provide, to the AMF, an AM policy association create response message that includes the disaster roaming policy for the UE 105. For example, the PCF may generate an AM policy association create response message that includes the disaster roaming policy determined for the UE 105. The PCF may provide the AM policy association create response to the AMF, and the AMF may receive the AM policy association create response from the PCF. The AM policy association create response may provide the AMF with policy directives to effectively manage connectivity and network interactions of the UE 105 during the disaster event. Additionally, or alternatively, the PCF may provide a preliminary disaster roaming policy to the AMF, and may subsequently update the disaster roaming policy in real-time as more information about the disaster event becomes available. For example, real-time data from emergency services may be utilized by the PCF to refine the preliminary disaster roaming policy to better align with evolving needs during the disaster event.

As shown at step 5 of FIG. 1B, the AMF may utilize the disaster roaming policy for the UE 105 to provide a service to the UE 105 based on the NAS registration request. For example, the AMF may utilize the disaster roaming policy to prioritize access to network resources by the UE 105. This may ensure that communication with the UE 105 remains robust and reliable even during large-scale emergencies. Additionally, or alternatively, the AMF may utilize the disaster roaming policy to enable specific emergency communication services, such as priority voice calls or emergency broadcast messages, tailored to the needs of the UE 105 during the disaster event. For example, the AMF may automatically activate emergency broadcast channels to disseminate critical information to the UE 105 in real-time.

In some implementations, the disaster roaming policy may include specific QoS parameters tailored for the disaster event. Alternatively, or additionally, the AMF may utilize the disaster roaming policy to provide differentiated network treatment for the UE 105 during the disaster event. For example, the AMF may modify existing network policies based on the disaster roaming policy to prioritize network resources for the UE 105. In some implementations, the differentiated network treatment may include providing the UE 105 with access to network slices optimized for the disaster event.

In some implementations, the PCF may receive a change associated with network conditions or the disaster event, and may update the disaster roaming policy in response to the change associated with the network conditions or the disaster event. Alternatively, or additionally, the PCF may notify the UE 105 of the disaster roaming policy, and/or may receive, from the AMF, feedback associated with implementation of the disaster roaming policy. Alternatively, or additionally, the PCF may log information associated with the disaster event and implementation of the disaster roaming policy for analysis and optimization.

In some implementations, the PCF may manage disaster roaming by determining and implementing policies that govern network behavior during disaster events. The PCF may evaluate various factors, including subscriber price plans, geographic location, and network conditions, to generate appropriate policies. These policies may be communicated to the AMF or the SMF, which enforce them to regulate network activities. By ensuring that policies are tailored to the specific needs of disaster roaming subscribers, the PCF facilitates efficient network resource allocation, enhances QoS, and supports critical communications during emergencies.

FIG. 1C depicts an example information flow associated with providing disaster roaming policy support. As shown at step 1 of FIG. 1C, the AMF may receive, from the UE 105, a packet data unit (PDU) session establishment request that includes a SUPI, a serving PLMN, and a disaster roaming type for the UE 105. For example, based on a disaster event, the UE 105 may generate the PDU session establishment request that includes the SUPI, the serving PLMN, and the disaster roaming registration type for the UE 105. The UE 105 may provide the PDU session establishment request to the AMF, and the AMF may receive the PDU session establishment request from the UE 105. In some implementations, the UE 105 provide the PDU session establishment request to the AMF as part of initiating disaster roaming, ensuring that the UE 105 can access network services during the disaster event without the need for traditional roaming agreements.

As shown at step 2 of FIG. 1C, the SMF may receive the PDU session establishment request from the AMF. For example, the AMF may forward the PDU session establishment request (e.g., with the SUPI, the serving PLMN, and the disaster roaming registration type for the UE 105) to the SMF, and the SMF may receive the PDU session establishment request from the AMF. This may ensure that the SMF is informed of the UE 105 engaging in disaster roaming. In some implementations, the SMF may receive a modified PDU session establishment request from the AMF. The modified PDU session establishment request may include additional parameters, such as emergency contact details or geographic location information to assist in prioritizing network resources. The additional parameters may enable the SMF to tailor network resources effectively, and to ensure that urgent communications are prioritized based on circumstances of the UE 105 during the disaster event.

As shown at step 3 of FIG. 1C, the PCF may receive, from the SMF, a session management (SM) policy association create message that includes the SUPI, the serving PLMN, and the disaster roaming registration type for the UE 105. For example, the SMF may generate the SM policy association create message based on receiving the PDU session establishment request from the AMF. The SMF may include the SUPI, the serving PLMN, and the disaster roaming registration type for the UE 105 in the SM policy association create message. The SMF may provide the SM policy association create message (e.g., with the SUPI, the serving PLMN, and the disaster roaming registration type for the UE 105) to the PCF, and the PCF may receive the SM policy association create message from the SMF. The SM policy association create message may enable the PCF to recognize the context of the disaster roaming registration, and to facilitate creation of a specialized policy for the UE 105.

As shown at step 4 of FIG. 1C, the PCF may determine a disaster roaming policy for the UE 105 based on the disaster roaming registration type. For example, when the PCF receives the SM policy association create message, the PCF may determine the disaster roaming policy for the UE 105 based on the disaster roaming registration type included in the SM policy association create message. In some implementations, the PCF may analyze the disaster roaming registration type and other contextual information to formulate a policy that optimizes network resource allocation and QoS parameters for emergency conditions. Additionally, or alternatively, the PCF may determine the disaster roaming policy based on historical data or a predictive analytics model that anticipates network needs during a disaster, rather than solely based on the disaster roaming registration type. For example, the PCF may utilize a machine learning model (e.g., trained on past disaster scenarios) to proactively adapt the disaster roaming policy to ensure optimal resource distribution during emergencies. Additionally, or alternatively, the PCF may determine the disaster roaming policy by incorporating real-time data analytics that evaluate network congestion levels and predict resource demands during the disaster event. The PCF may utilize such analytics to dynamically adjust the policy parameters for the disaster roaming policy. The analytics may provide insights into current network conditions, and may enable the PCF to adapt policies to meet evolving demands during the disaster event.

As shown at step 5 of FIG. 1C, the PCF may provide, to the SMF, an SM policy association create response message that includes the disaster roaming policy for the UE 105. For example, the PCF may generate an SM policy association create response message that includes the disaster roaming policy determined for the UE 105. The PCF may provide the SM policy association create response to the SMF, and the SMF may receive the SM policy association create response from the PCF. The SM policy association create response may provide the SMF with policy directives to effectively manage connectivity and network interactions of the UE 105 during the disaster event. Additionally, or alternatively, the PCF may provide a preliminary disaster roaming policy to the SMF, and may subsequently update the disaster roaming policy in real-time as more information about the disaster event becomes available. For example, real-time data from emergency services may be utilized by the PCF to refine the preliminary disaster roaming policy to better align with evolving needs during the disaster event.

As shown at step 6 of FIG. 1C, the SMF may utilize the disaster roaming policy for the UE 105 to provide a service to the UE 105 based on the PDU session establishment request. For example, the SMF may utilize the disaster roaming policy to prioritize access to network resources by the UE 105. This may ensure that communication with the UE 105 remains robust and reliable even during large-scale emergencies. Additionally, or alternatively, the SMF may utilize the disaster roaming policy to enable specific emergency communication services, such as priority voice calls or emergency broadcast messages, tailored to the needs of the UE 105 during the disaster event. For example, the SMF may automatically activate emergency broadcast channels to disseminate critical information to the UE 105 in real-time.

In some implementations, the disaster roaming policy may include specific QoS parameters tailored for the disaster event. Alternatively, or additionally, the SMF may utilize the disaster roaming policy to provide differentiated network treatment for the UE 105 during the disaster event. For example, the SMF may modify existing network policies based on the disaster roaming policy to prioritize network resources for the UE 105. In some implementations, the differentiated network treatment may include providing the UE 105 with access to network slices optimized for the disaster event or managing bandwidth allocation for the UE 105 during the disaster event.

To ensure effective implementation of disaster roaming, the implementations described herein may be activated under specific conditions. These conditions may include the activation of the Federal Emergency Management Agency’s (FEMA’s) Emergency Support Function (ESF-2), the activation of the Federal Communications Commission’s (FCC’s) Disaster Information Reporting System (DIRS), and the issuance of a public notice by the Chief of the FCC’s Public Safety and Homeland Security Bureau upon request by a state. Additionally, state-level activation of Emergency Operations, mutual aid, or a local state of emergency proclamation may also trigger disaster roaming. These predefined conditions may ensure that the disaster roaming feature is employed during genuine emergencies, optimizing resource allocation and maintaining critical communications.

In some implementations, N15 and N7 interface specifications may be enhanced to enable better communication between network devices, such as the AMF, the SMF, and the PCF. Through these enhancements, the interfaces may provide specific indications that differentiate disaster roaming from regular roaming activities. This differentiation may enable creation of tailored AM, UE, and SM policies specifically for disaster roaming scenarios. By incorporating these enhancements, the network may effectively manage and prioritize resources during emergencies, providing the necessary support for disaster roaming users without conflating their requirements with regular roaming users.

In this way, implementations described herein provide disaster roaming policy support. For example, the implementations enable 5G networks to differentiate disaster roaming from regular roaming and implement policies optimized for emergency scenarios. By prioritizing network resources for disaster roaming users and tailoring QoS parameters for emergency situations, the implementations may prevent inefficient allocation of resources during large-scale emergencies. Additionally, the implementations improve the technical reliability of emergency communications by implementing differentiated resource management and policy adjustments, thereby avoiding unnecessary network congestion and ensuring efficient utilization of limited bandwidth and other communication infrastructure resources. Thus, the implementations may conserve computing resources, networking resources, and/or other resources that would have otherwise been consumed by failing to implement customized policies for disaster roaming users, creating inefficiencies in resource allocation and QoS management due to failing to implement customized policies for disaster roaming users, impacting the reliability and performance of emergency communications, and/or the like.

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

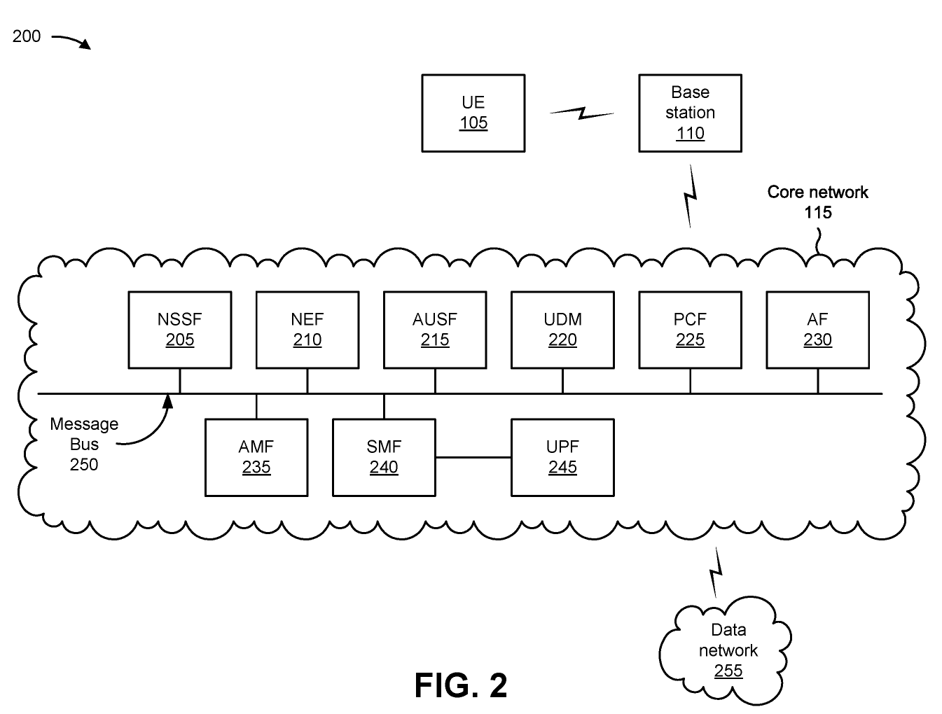

FIG. 2 is a diagram of an example environment 200 in which systems and/or methods described herein may be implemented. As shown in FIG. 2, the example environment 200 may include the UE 105, the base station 110, the core network 115, and a data network 255. Devices and/or networks of the example environment 200 may interconnect via wired connections, wireless connections, or a combination of wired and wireless connections.

The UE 105 includes one or more devices capable of receiving, generating, storing, processing, and/or providing information, such as information described herein. For example, the UE 105 may include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The base station 110 may support, for example, a cellular radio access technology (RAT). The base station 110 may include one or more base stations (e.g., base transceiver stations, radio base stations, node Bs, eNodeBs (eNBs) (e.g., the 4G base station 110), gNodeBs (gNBs) (e.g., the 5G base stations 110-1 and 110-2), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The base station 110 may transfer traffic between the UE 105 (e.g., using a cellular RAT), one or more base stations (e.g., using a wireless interface or a backhaul interface, such as a wired backhaul interface), and/or the core network 115. The base station 110 may provide one or more cells that cover geographic areas.

In some implementations, the base station 110 may perform scheduling and/or resource management for the UE 105 covered by the base station 110 (e.g., the UE 105 covered by a cell provided by the base station 110). In some implementations, the base station 110 may be controlled or coordinated by a network controller, which may perform load balancing, network-level configuration, and/or other operations. The network controller may communicate with the base station 110 via a wireless or wireline backhaul. In some implementations, the base station 110 may include a network controller, a self-organizing network (SON) module or component, or a similar module or component. In other words, the base station 110 may perform network control, scheduling, and/or network management functions (e.g., for uplink, downlink, and/or sidelink communications of the UE 105 covered by the base station 110).

In some implementations, the core network 115 may include an example functional architecture in which systems and/or methods described herein may be implemented. For example, the core network 115 may include an example architecture of a fifth generation (5G) next generation (NG) core network included in a 5G wireless telecommunications system. While the example architecture of the core network 115 shown in FIG. 2 may be an example of a service-based architecture, in some implementations, the core network 115 may be implemented as a reference-point architecture and/or a 4G core network, among other examples.

As shown in FIG. 2, the core network 115 may include a number of functional elements. The functional elements may include, for example, a network slice selection function (NSSF) 205, a network exposure function (NEF) 210, an authentication server function (AUSF) 215, a unified data management (UDM) component 220, a policy control function (PCF) 225, an application function (AF) 230, an AMF 235, an SMF 240, and/or a user plane function (UPF) 245. These functional elements may be communicatively connected via a message bus 250. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 205 includes one or more devices that select network slice instances for the UE 105. By providing network slicing, the NSSF 205 allows an operator to deploy multiple substantially independent end-to-end networks potentially with the same infrastructure. In some implementations, each slice may be customized for different services.

The NEF 210 includes one or more devices that support exposure of capabilities and/or events in the wireless telecommunications system to help other entities in the wireless telecommunications system discover network services.

The AUSF 215 includes one or more devices that act as an authentication server and support the process of authenticating the UE 105 in the wireless telecommunications system.

The UDM 220 includes one or more devices that store user data and profiles in the wireless telecommunications system. The UDM 220 may be used for fixed access and/or mobile access in the core network 115.

The PCF 225 includes one or more devices that provide a policy framework that incorporates network slicing, roaming, packet processing, and/or mobility management, among other examples.

The AF 230 includes one or more devices that support application influence on traffic routing, access to the NEF 210, and/or policy control, among other examples.

The AMF 235 includes one or more devices that act as a termination point for non-access stratum (NAS) signaling and/or mobility management, among other examples.

The SMF 240 includes one or more devices that support the establishment, modification, and release of communication sessions in the wireless telecommunications system. For example, the SMF 240 may configure traffic steering policies at the UPF 245 and/or may enforce user equipment Internet protocol (IP) address allocation and policies, among other examples.

The UPF 245 includes one or more devices that serve as an anchor point for intraRAT and/or interRAT mobility. The UPF 245 may apply rules to packets, such as rules pertaining to packet routing, traffic reporting, and/or handling user plane QoS, among other examples.

The message bus 250 represents a communication structure for communication among the functional elements. In other words, the message bus 250 may permit communication between two or more functional elements.

The data network 255 includes one or more wired and/or wireless data networks. For example, the data network 255 may include an IP Multimedia Subsystem (IMS), a PLMN, a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example environment 200 may perform one or more functions described as being performed by another set of devices of the example environment 200.

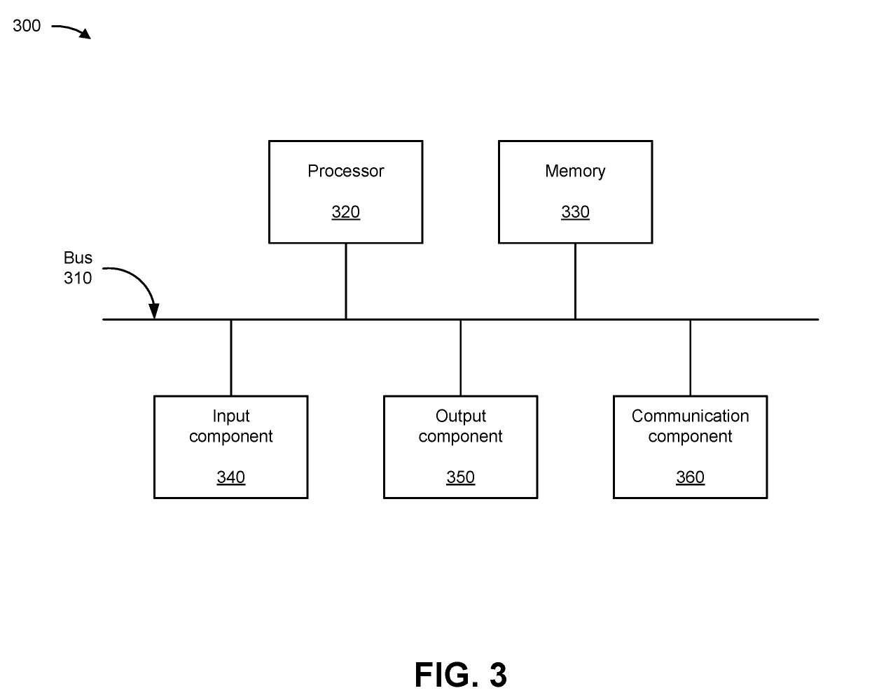

FIG. 3 is a diagram of example components of a device 300, which may correspond to the UE 105, the base station 110, the NSSF 205, the NEF 210, the AUSF 215, the UDM 220, the PCF 225, the AF 230, the AMF 235, the SMF 240, and/or the UPF 245. In some implementations, the UE 105, the base station 110, the NSSF 205, the NEF 210, the AUSF 215, the UDM 220, the PCF 225, the AF 230, the AMF 235, the SMF 240, and/or the UPF 245 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

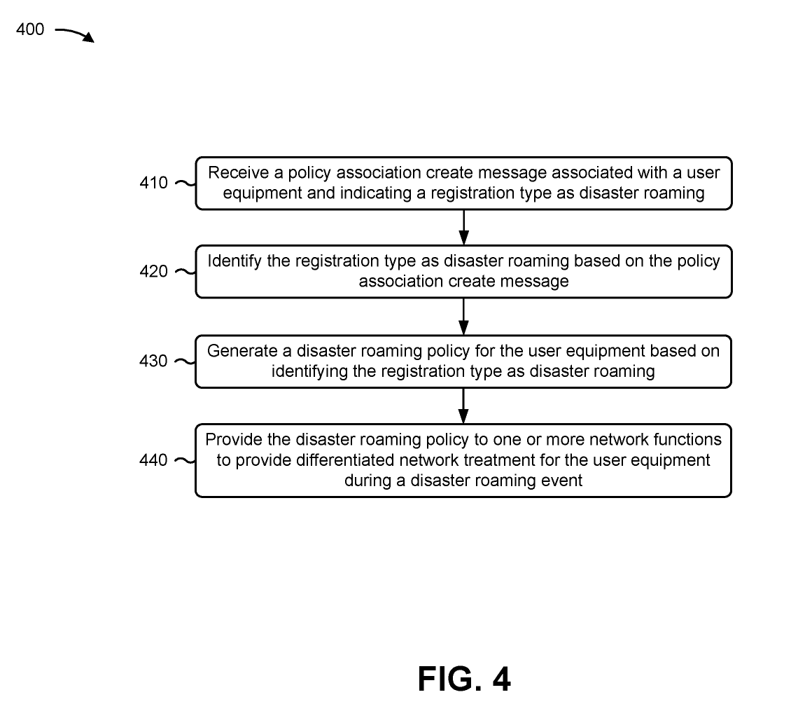

FIG. 4 is a flowchart of an example process 400 for providing disaster roaming policy support. In some implementations, one or more process blocks of FIG. 4 may be performed by a network device (e.g., the PCF 225). In some implementations, one or more process blocks of FIG. 4 may be performed by another network device or a group of network devices separate from or including the network device, such an AMF (e.g., the AMF 235), an SMF (e.g., the SMF 240), and/or the like. Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving a policy association create message associated with a UE and indicating a registration type as disaster roaming (block 410). For example, the network device may receive a policy association create message associated with a UE and indicating a registration type as disaster roaming, as described above. In some implementations, the policy association create message includes a message received from an AMF. In some implementations, the policy association create message includes a message received from an SMF. In some implementations, the policy association create message includes a SUPI and a serving PLMN identifier associated with the UE.

As further shown in FIG. 4, process 400 may include identifying the registration type as disaster roaming based on the policy association create message (block 420). For example, the network device may identify the registration type as disaster roaming based on the policy association create message, as described above.

As further shown in FIG. 4, process 400 may include generating a disaster roaming policy for the UE based on identifying the registration type as disaster roaming (block 430). For example, the network device may generate a disaster roaming policy for the UE based on identifying the registration type as disaster roaming, as described above. In some implementations, the disaster roaming policy includes specific QoS parameters tailored for the disaster roaming event.

As further shown in FIG. 4, process 400 may include providing the disaster roaming policy to one or more network functions to provide differentiated network treatment for the UE during a disaster roaming event (block 440). For example, the network device may provide the disaster roaming policy to one or more network functions to provide differentiated network treatment for the UE during a disaster roaming event, as described above. In some implementations, the differentiated network treatment includes access to network slices optimized for the disaster roaming event. In some implementations, the one or more network functions include an AMF and an SMF.

In some implementations, process 400 includes differentiating the policy association create message from a regular roaming message based on the SUPI, the serving PLMN, and identifying the registration type as disaster roaming. In some implementations, process 400 includes modifying existing network policies based on the disaster roaming policy to prioritize network resources for the UE.

In some implementations, process 400 includes receiving a change associated with network conditions or the disaster roaming event, and updating the disaster roaming policy in response to the change associated with the network conditions or the disaster roaming event. In some implementations, process 400 includes notifying the user equipment of the disaster roaming policy. In some implementations, process 400 includes receiving, from the one or more network functions, feedback associated with implementation of the disaster roaming policy. In some implementations, process 400 includes logging information associated with the disaster roaming event and the disaster roaming policy for analysis and optimization.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a network device, a policy association create message associated with a user equipment and indicating a registration type as disaster roaming;
identifying, by the network device, the registration type as disaster roaming based on the policy association create message;
generating, by the network device, a disaster roaming policy for the user equipment based on identifying the registration type as disaster roaming; and
providing, by the network device, the disaster roaming policy to one or more network functions to provide differentiated network treatment for the user equipment during a disaster roaming event.

2. The method of claim 1, wherein the policy association create message includes a message received from an access and mobility management function.

3. The method of claim 1, wherein the policy association create message includes a message received from a session management function.

4. The method of claim 1, wherein the policy association create message includes a subscriber permanent identifier (SUPI) and a serving public land mobile network (PLMN) identifier associated with the user equipment.

5. The method of claim 4, further comprising:
differentiating the policy association create message from a regular roaming message based on the SUPI, the serving PLMN, and identifying the registration type as disaster roaming.

6. The method of claim 1, wherein the disaster roaming policy includes specific quality of service parameters tailored for the disaster roaming event.

7. The method of claim 1, further comprising:
modifying existing network policies based on the disaster roaming policy to prioritize network resources for the user equipment.

8. A network device, comprising:
one or more processors configured to:
receive a policy association create message associated with a user equipment and indicating a registration type as disaster roaming;
identify the registration type as disaster roaming based on the policy association create message;
generate a disaster roaming policy for the user equipment based on identifying the registration type as disaster roaming;
provide the disaster roaming policy to one or more network functions to provide differentiated network treatment for the user equipment during a disaster roaming event; and
modify existing network policies based on the disaster roaming policy to prioritize network resources for the user equipment.

9. The network device of claim 8, wherein the differentiated network treatment includes access to network slices optimized for the disaster roaming event.

10. The network device of claim 8, wherein the one or more processors are further configured to:
receive a change associated with network conditions or the disaster roaming event; and
update the disaster roaming policy in response to the change associated with the network conditions or the disaster roaming event.

11. The network device of claim 8, wherein the one or more processors are further configured to:
notify the user equipment of the disaster roaming policy.

12. The network device of claim 8, wherein the one or more network functions include an access and mobility management function and a session management function.

13. The network device of claim 8, wherein the one or more processors are further configured to:
receive, from the one or more network functions, feedback associated with implementation of the disaster roaming policy.

14. The network device of claim 8, wherein the one or more processors are further configured to:
log information associated with the disaster roaming event and the disaster roaming policy for analysis and optimization.

15. A non-transitory computer-readable medium storing a set of instructions, the set of instructions comprising:
one or more instructions that, when executed by one or more processors of a network device, cause the network device to:
receive a policy association create message associated with a user equipment and indicating a registration type as disaster roaming;
identify the registration type as disaster roaming based on the policy association create message;
generate a disaster roaming policy for the user equipment based on identifying the registration type as disaster roaming;
provide the disaster roaming policy to one or more network functions to provide differentiated network treatment for the user equipment during a disaster roaming event; and
log information associated with the disaster roaming event and the disaster roaming policy for analysis and optimization.

16. The non-transitory computer-readable medium of claim 15, wherein the policy association create message includes a message received from an access and mobility management function.

17. The non-transitory computer-readable medium of claim 15, wherein the policy association create message includes a message received from a session management function.

18. The non-transitory computer-readable medium of claim 15, wherein the one or more instructions further cause the network device to:
modify existing network policies based on the disaster roaming policy to prioritize network resources for the user equipment.

19. The non-transitory computer-readable medium of claim 15, wherein the one or more instructions further cause the network device to:
receive a change associated with network conditions or the disaster roaming event; and
update the disaster roaming policy in response to the change associated with the network conditions or the disaster roaming event.

20. The non-transitory computer-readable medium of claim 15, wherein the one or more instructions further cause the network device to:
notify the user equipment of the disaster roaming policy.
